(19) United States
(12) Patent Application Publication
(10) Pub. No.: US 2024/0369184 A1
(43) Pub. Date: Nov. 7, 2024

(54) Pressure Vessel, Pressure Vessel System, Motor Vehicle and Method for Forming Ribs

(71) Applicant: Bayerische Motoren Werke Aktiengesellschaft, Muenchen (DE)

(72) Inventors: Martin SCHOLZ, Unterschleissheim (DE); Klaus SZOUCSEK, Zirndorf (DE)

(21) Appl. No.: 18/291,612

(22) PCT Filed: Jul. 28, 2022
(86) PCT No.: PCT/EP2022/071178

§ 371 Date: Jan. 24, 2024

(30) Foreign Application Priority Data
Jul. 28, 2021 (DE) 102021119604.3
Sep. 20, 2021 (DE) 102021124236.3

(51) Int. Cl. F17C 1/00

(52) U.S. Cl. CPC F17C 1/00; F17C 2201/0123; F17C 2203/012; F17C 2203/0604; F17C 2203/0648; F17C 2205/0142

(57) ABSTRACT

A pressure vessel for storing gaseous fuel has a vessel wall which surrounds an interior, wherein one or more ribs are formed on the vessel wall. A pressure vessel system, particularly for a motor vehicle, includes at least two such pressure vessels. A method is disclosed to form the ribs on the vessel wall of the pressure vessel.

### BACKGROUND AND SUMMARY

The technology disclosed here relates to a pressure vessel for storing gaseous fuel, a pressure vessel system having two or more such pressure vessels, a motor vehicle, and a method for forming ribs on a vessel wall of a pressure vessel.

Pressure vessels are typically used to provide gaseous fuel in mobile or stationary units, for example in motor vehicles. For example, a gas-powered internal combustion engine or a fuel cell can be driven with the gaseous fuel.

A preferred object of the technology disclosed here is to reduce or eliminate at least one disadvantage of a previously known solution or to propose an alternative solution. In particular, a preferred object of the technology disclosed here is to provide a pressure vessel with improved stability. Other preferred objects may result from the advantageous effects of the technology disclosed here. The objects are achieved by the subject matter of the independent claims. The dependent claims represent preferred embodiments.

The technology disclosed here relates to a pressure vessel for storing gaseous fuel. The pressure vessel comprises a vessel wall which encloses an interior. One or more ribs are formed on the vessel wall.

The stability of the pressure vessel can be increased by means of such ribs. In particular, the ribs can be used specifically as structural elements to improve the rigidity of the pressure vessel, for example to design it for higher pressures or special requirements. Other advantageous configurations are also possible, which are described in more detail below by way of example.

A vessel wall can be understood in particular to mean a wall which encloses the interior. The gaseous fuel is typically stored under pressure and/or at particularly low temperatures in the interior. Ribs are to be understood in particular as projections which protrude from a surrounding surface. They are typically visually recognizable as such and can be distinguished on account of their protruding character. If a rib cannot be precisely defined on account of the smooth transitions of a structure, this does not negate its properties as a rib. Rather, a suitable definition can be chosen, for example a minimum elevation over a surrounding surface area or a surrounding depression.

According to one embodiment, one, some or all of the ribs are formed from the same material as the vessel wall. This in particular permits simple production and a stable material connection between the ribs and the other parts of the vessel wall.

According to one embodiment, one, some or all of the ribs are formed from a different material than the vessel wall. As a result, the ribs can be given special properties through suitable selection of material.

The designs of the ribs made from the same material as the vessel wall and of a different material than the vessel wall can also be combined, so that for example some ribs can be made from the same material and some ribs can be made from a different material. As a result, specific properties can be achieved through combinations of material.

According to one embodiment, one, some or all of the ribs are formed from metal and/or of carbon fiber reinforced plastic. Such materials have proven advantageous because of their strength. However, other materials can also be used.

In particular, adjoining planes of some or all of the ribs can be oriented parallel to one another. This permits a simple design and an advantageous and uniform increase in stability.

In particular, the ribs can be of the same width and/or have identical distances from respective immediately adjacent ribs. Ribs at the axial end can in particular have only one adjacent rib, i.e. on one side. This permits a simple design with a uniform influence on stability. However, non-uniform designs are also possible.

Dimensions are given below that have proven advantageous for typical purposes. In particular, this applies to the use in an installation space below a passenger compartment of a motor vehicle, such an installation space typically being relatively flat and thus suitable for the installation of a plurality of pressure vessels next to one another. These pressure vessels can be combined to form a pressure vessel system, for example, as is described further below. Such a pressure vessel system can, in particular, have a common connection line for all the pressure vessels, which can in particular enable pressure equalization between the pressure vessels at any time.

A wall thickness of the pressure vessel can be at least 5.4 mm and/or at most 7.5 mm, in particular between the ribs. This typically applies to regions lying axially between the ribs. However, the wall thickness is typically measured radially.

In particular, the axial length of a pressure vessel can be at least 1,500 mm and/or at most 2,000 mm. A diameter of a pressure vessel can in particular be at least 120 mm and/or at most 175 mm.

A height of the ribs relative to the immediately surrounding vessel wall can be in particular at least 1 mm, at least 2 mm, at least 4 mm or at least 6 mm. In particular, it can be at most 2 mm, at most 3 mm, at most 4 mm, at most 6 mm or at most 7 mm. The height can be measured in particular as a projection over the immediately adjacent vessel wall. This can apply to both the inside and the outside.

A width of the ribs can in particular be at least 20 mm, at least 25 mm, at least 30 mm or at least 35 mm. It can in particular be at most 25 mm, at most 30 mm, at most 35 mm or at most 40 mm. The width can in particular be measured axially, i.e. along a longitudinal direction of the pressure vessel.

A distance between immediately adjacent ribs can in particular be at least 10 mm or at least 15 mm. In particular, it can be at most 15 mm or at most 20 mm. A distance can in particular be measured axially, i.e. along a longitudinal direction of the pressure vessel.

According to a development, it is provided that one or more circumferential reinforcement layers are formed between immediately adjacent outer ribs. These reinforcement layers can be located in particular in interstices between the ribs. They can in particular fill the respective interstices axially. In particular, the ribs can protrude further compared to the reinforcement layers. In this way, they can provide mechanical protection for the reinforcement layers.

The reinforcement layers can in particular be made of carbon fiber reinforced plastic. This achieves an advantageous additional stability. In particular, the stability can be achieved with less material than when using steel alone. Carbon fiber reinforced plastic can also be referred to as CFRP.

The reinforcement layers can in particular be unidirectional. In particular, they can extend along a circumference. This achieves an advantageous absorption of outwardly directed forces.

A height of the ribs can in particular be at least 20% and/or at most 30% greater than a height of the reinforcement layers. In particular, a height can be measured relative to a surrounding (in the case of the ribs) or underlying (in the case of the reinforcement layers) vessel wall. In particular, the height of the ribs can be 25% higher than the height of the reinforcement layers. This allows for the fact that the strength of CFRP material can be, for example, about 25% greater than that of steel. For example, the strength of steel can be 2,000 MPa and the strength of CFRP material can be 2,500 MPa.

According to an advantageous embodiment, a barrier layer is formed between the vessel wall and the interior. This barrier layer can contribute in particular to reducing or preventing diffusion of gaseous fuel, in particular hydrogen, into the vessel wall. This can have an advantageous effect on the long-term properties of the vessel wall.

In particular, the barrier layer can completely line the inside of the vessel wall. As a result, seamless protection of the vessel wall is achieved by the barrier layer. The barrier layer can also line at least 70%, at least 80% or at least 90% of the vessel wall on the inside.

The barrier layer can be formed in particular from ethylene vinyl alcohol copolymer (EVOH). This has proven particularly advantageous for preventing hydrogen from diffusing into the vessel wall. However, other materials can also be used.

The barrier layer can advantageously have an ethylene content of between 20 mol % and 28 mol %, or particularly preferably 24 mol %. Such ethylene contents ensure good manufacturability and, at the same time, good suppression of inward diffusion of hydrogen. However, other values can also be used. These values are in particular preferred when the barrier layer made of ethylene vinyl alcohol copolymer is used.

The barrier layer can in particular have a thickness of between 80 μm and 250 μm. Such values have proven advantageous. For example, a thickness of 200 μm may be sought in order to safely achieve a thickness of 130 μm everywhere, taking unevenness into account.

Furthermore, a metal layer can advantageously be arranged between the barrier layer and the vessel wall. This metal layer can additionally contribute to preventing hydrogen permeation.

The metal layer can be made of copper or a copper alloy, for example. It can also be made of another metal or a metal alloy. In particular, it can be combined with a barrier layer made of plastic, for example as mentioned above.

In particular, when using a barrier layer and/or metal layer, it can be provided that all the ribs on the vessel wall are formed on the outside. This combination has proven particularly advantageous with regard to the durability of the vessel wall, especially when using hydrogen as the gaseous fuel. The inward diffusion of hydrogen is effectively prevented and, at the same time, hydrogen that has nevertheless penetrated is better released via the outer surface, which is enlarged by means of the ribs on the outside.

Furthermore, an anti-corrosion layer can be applied to the outside of the vessel wall. This layer can prevent or slow down any corrosion.

The anti-corrosion layer can in particular be made of a zinc-nickel alloy. This material has proven advantageous for typical applications. In particular, it allows hydrogen to diffuse out to the environment. However, other materials can also be used.

The anti-corrosion layer is particularly advantageous when the pressure vessel is used without a watertight housing.

According to one embodiment, one, some or all of the ribs of the vessel wall are formed on the inside. The ribs are thus formed toward the interior and in particular come into contact with a gaseous fuel stored in the pressure vessel.

According to one embodiment, one, some or all of the ribs are formed on the outside of the vessel wall. These ribs typically do not come into contact the gaseous fuel stored in the interior, but they do come into contact with a surrounding atmosphere.

Inner and outer ribs can also be combined with each other. In particular, they can be formed in alternation. This may mean in particular that outer and inner ribs continuously alternate along a longitudinal axis of the pressure vessel. In particular, the outer and inner ribs can follow one another directly along the longitudinal axis. However, they can also have certain distances from one another.

The technology disclosed here also relates to a pressure vessel system. The latter comprises two or more pressure vessels as described herein. Ribs of one, some or all of the pressure vessels engage in interstices between ribs of one or more immediately adjacent pressure vessels.

A number of advantages can be achieved by such a pressure vessel system. In particular, space can be saved by the engagement of the ribs in interstices. By suitable clamping of the ribs against one another, a stable position of the pressure vessels relative to one another can be established. Alternatively or in addition, a holding device can also be present, which brings about such an arrangement.

The longitudinal axes of the pressure vessels can in particular be oriented parallel to one another. This permits a simple design which is particularly suitable, for example, for installation in an underfloor area of a motor vehicle.

The ribs of immediately adjacent pressure vessels can in particular be designed without any axial offset from one another relative to at least one longitudinal end of the pressure vessel. Immediately adjacent pressure vessels can in particular be arranged axially offset from one another. This results in an embodiment in which identical pressure vessels can be used, with a slight axial offset of the pressure vessels being accepted. Outside of the ribs, there may also be differences between the pressure vessels, which fact does not affect the relevant functionality here. An embodiment of the ribs without an axial offset from one another relative to at least one longitudinal end of the pressure vessel can be understood in particular to mean that, starting from a respective longitudinal end of the at least two pressure vessels under consideration, the ribs are at the same distance from this longitudinal end. This is then taken into account, in the pressure vessel system, by an axial offset of the pressure vessels relative to one another.

According to one embodiment, the ribs of immediately adjacent pressure vessels are offset axially from the immediately adjacent pressure vessel. Immediately adjacent pressure vessels are in particular arranged axially non-offset from one another with respect to a longitudinal end or both longitudinal ends. As a result, it can be achieved that the pressure vessels extend uniformly along their respective longitudinal direction, that is to say they do not differ from adjacent pressure vessels in this respect. This can enable better utilization of installation space and/or better load distribution. Typically, two different pressure vessels are required for such an embodiment, so that they can be used alternately and respective ribs can engage in interstices between adjacent pressure vessels.

Ribs of immediately adjacent pressure vessels can in particular have aligned through-holes, through which a fastening means runs. In this way, the safety of the pressure vessel system against slipping can be increased. For example, the fastening means can be a wire which can run through the through-holes.

Ribs of immediately adjacent pressure vessels can in particular be connected to one another by force-fit engagement. This achieves simple and reliable fastening of the pressure vessels to one another.

In particular, the pressure vessels can be connected by a common connection line, in which case a pressure equalization between the pressure vessels is at no point impaired by valves. The connection line can have a tank shut-off valve, for example, with which all the pressure vessels can be shut off or released at the same time. The common connection line ensures that pressure equalization between the pressure vessels is possible at any time. As a result, they have the same internal pressure. During operation, in the event of fluctuating pressures, this means that the pressure vessels always expand at the same rate. And it means that the interlocking ribs always maintain the same gap with respect to the neighboring rib.

The technology disclosed here also relates to a motor vehicle having a pressure vessel system as described herein, the pressure vessel system being installed in an underfloor installation space of the motor vehicle. As regards the pressure vessel system, all the variants described herein can be used. The installation of such a pressure vessel system in an underfloor installation space of a motor vehicle brings with it the particular advantages that the pressure vessel system described herein is particularly well adapted to a flat design and is very compact and easy to handle. An underfloor installation space is typically an installation space below the passenger compartment of a motor vehicle, which space is typically relatively flat.

The technology disclosed here also relates to a method for forming ribs from a vessel wall of a pressure vessel. For this method, three different procedures are described below.

According to one embodiment, the ribs are produced separately, and the ribs are applied with a force-fit to the vessel wall by means of cold forming. As a result, the ribs can be manufactured separately, for example from a different material, or from the same material as the vessel wall.

According to one embodiment, an internal pressure is applied to the pressure vessel, with the pressure vessel being cold-formed so as to form the ribs. The well-known process of cold forming can be used for this purpose. This can be used in particular when the ribs are to be formed from the same material as the vessel wall.

According to one embodiment, the ribs are produced separately and the ribs are thermally shrunk onto the vessel wall. This allows the ribs to be manufactured separately, for example from a different material than the vessel wall, or from the same material. Shrinking is a reliable technology for connecting the ribs to the vessel wall.

The method can also comprise a step of introducing a barrier layer to the inside of the vessel wall. This can be carried out in particular by rotomolding, blow molding or extrusion. Such procedures have proven advantageous for introduction of a barrier layer. The barrier layer can be formed in particular as described above.

A rotomolding process can be carried out in particular at a temperature of 190° C. to 270° C. This melts a suitable material such as EVOH but does not adversely affect its properties.

The tightness of a barrier layer after production can be checked using an endoscope, for example.

A pressure vessel system can be understood in particular as a fuel supply system which contains a number of pressure vessels and associated valves such as shut-off valves, check valves and thermal pressure relief devices which are needed to separate and store gaseous fuel, which is typically under high pressure and/or is stored particularly cold, in a vehicle.

The pressure vessel system can be used, for example, for a motor vehicle (for example passenger cars, motorcycles, commercial vehicles). The pressure vessel system serves in particular to store fuel that is gaseous under ambient conditions. The pressure vessel system can be used, for example, in a motor vehicle that is operated with compressed natural gas (CNG) or liquefied natural gas (LNG) or with hydrogen. The pressure vessel system is typically fluidically connected to at least one energy converter that is configured to convert the chemical energy of the fuel into other forms of energy.

Such a pressure vessel system typically comprises at least one pressure vessel, in particular a composite overwrapped pressure vessel. The pressure vessel can be, for example, a cryogenic pressure vessel or a high-pressure gas vessel.

High-pressure gas vessels are designed to permanently store fuel at ambient temperatures at a nominal operating pressure (also known as nominal working pressure or NWP) of at least 350 bar overpressure (=excess pressure compared to atmospheric pressure) or at least 700 bar overpressure. A cryogenic pressure vessel is suitable for storing the fuel at the aforementioned operating pressures even at temperatures that are significantly (for example more than 50 K or more than 100 K) below the operating temperature of the motor vehicle.

The pressure vessels can in particular have circular or oval cross sections. In particular, they can have a common shut-off valve, or they can have separate shut-off valves.

The vessel shut-off valve is typically a valve whose inlet pressure corresponds (substantially) to the vessel pressure. The vessel shut-off valve is in particular a valve which is controllable in open-loop and/or closed-loop fashion and which is in particular normally closed. In the Regulation (EU) no. 406/2010 of the Commission of Apr. 26, 2010 implementing Regulation (EC) no. 79/2009 of the European Parliament and of the Council concerning the type-approval of hydrogen-powered motor vehicles, such a vessel shut-off valve is also referred to as first valve.

In other words, steel tanks, for example, are usually designed as smooth cylinders. Ribs can be provided on the cylindrical tank wall. The ribs can be placed inside the tank or on the outside surface. They function in particular as reinforcement elements and make it possible to reduce the wall thickness (excluding ribs). This can be confirmed by FEM simulations.

For example, a steel tank can have a wall thickness of 4.5 mm (excluding ribs). This can absorb the same maximum tension on the inner surface as a ribless tank with a wall thickness of 5 mm. The ribs can be formed on the inside, on the outside, or both on the inside and outside.

The ribs can be made of metal or of CFRP (carbon fiber reinforced plastic), for example. Especially for the outer ribs, CFRP circumferential windings can be used to advantage. A high fiber volume content can be achieved there, and the carbon fibers are loaded in the tensile direction where they have their best strength properties. Outer ribs made of metal can be manufactured as rings and connected non-positively to the tank from the outside using cold forming. Internal pressure can also be applied to the tank so that it expands plastically and is thus cold-formed from the inside. It is also conceivable that the rings are shrunk on thermally. Using these production methods, it is also possible to introduce a slight elastic pretensioning into the tank wall, which counteracts the internal pressure load and thus improves the operational stability. Several identical tanks can be arranged in an underfloor tank system in such a way that the ribs are offset from one another. Such an arrangement has the advantage that the distance between the central axes of the tanks is smaller than when tanks without ribs are used. If identical tanks are used, they can be longitudinally offset by the rib spacing. Alternatively, two different tanks are used whose ribs are produced to be offset. This can simplify neck mounting, for example.

The outer ribs can also be used to fasten the tanks together. A metal wire can be inserted into holes in the ribs. Such a fastening has a remaining rotational degree of freedom, which can be supplemented in other ways with moment support. As an alternative to this, the ribs can be connected to one another by force-fit engagement, in which case they no longer have the rotational degree of freedom.

A nominal pressure of a pressure vessel can be 700 bar, for example.

The material of the pressure vessels can, after heat treatment, have the following properties for example:
Tensile strength of at least 1,500 MPa, preferably at least 1,700 MPa, particularly preferably at least 1,900 MPa,
and/or 0.2% yield point of at least 1,100 MPa, preferably at least 1,300 MPa, particularly preferably at least 1,500 MPa,
and/or elongation at break of at most 10%, preferably at most 8%, particularly preferably at most 6%.

The technology disclosed here will now be described with reference to the figures.

### BRIEF DESCRIPTION OF THE DRAWINGS

FIG. 1 shows a pressure vessel according to a first embodiment;

FIG. 2 shows a pressure vessel according to a second embodiment;

FIG. 3 shows a pressure vessel according to a third embodiment;

FIG. 4 shows a pressure vessel system according to a first embodiment;

FIG. 5 shows a pressure vessel system according to a second embodiment;

FIG. 6 shows a pressure vessel system according to a third embodiment;

FIG. 7 shows the pressure vessel system from FIG. 6 in a different view; and

FIG. 8 shows a pressure vessel according to a fourth embodiment.

### DETAILED DESCRIPTION OF THE DRAWINGS

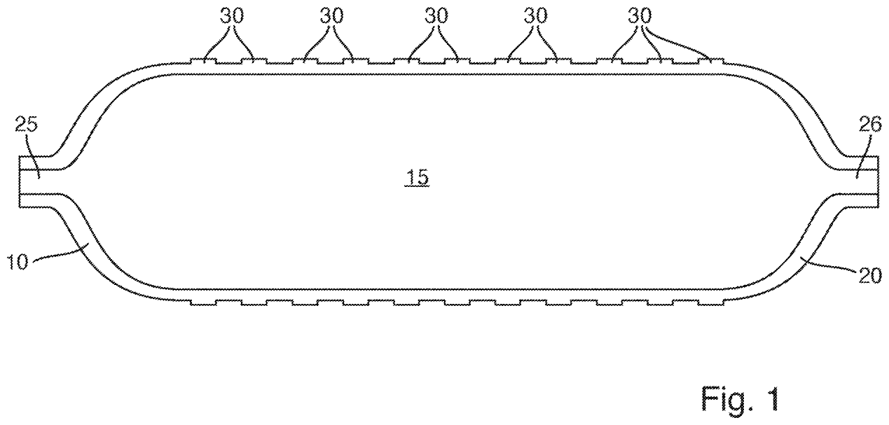

FIG. 1 shows a purely schematic view of a pressure vessel 10. The latter has a vessel wall 20 which encloses an interior 15. The vessel wall 20 has a first port 25 and a second port 26, through which the interior 15 can be filled and emptied.

In the present case, the pressure vessel 10 is designed as an elongate vessel with a circular cross section. The cross section can be seen transversely to the plane of the paper in FIG. 1.

A plurality of ribs 30 are formed on the outside of the vessel wall 20. These ribs 30 protrude outward. They run in the cross section already mentioned, are parallel to one another, are of the same length and have identical distances to one another. The pressure vessel 10 is reinforced by means of these outer ribs 30, such that, for example, a greater internal pressure can be used.

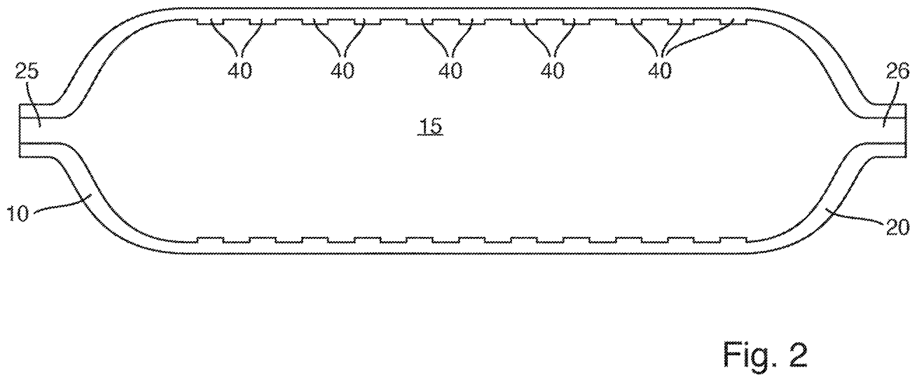

FIG. 2 shows a purely schematic view of a pressure vessel 10 according to a second embodiment. In the following, it is essentially only the differences from the first embodiment that will be discussed. As regards the other elements, reference is made to the description of FIG. 1. This also applies to the figures described further below.

In the pressure vessel 10 according to the second embodiment, inner ribs 40 are formed instead of the outer ribs 30. These inner ribs 40 also run parallel to one another in respective planes transverse to the plane of the paper in FIG. 2, and they too have identical dimensions in the longitudinal direction of the pressure vessel 10 and identical distances from one another. A reinforcement of the pressure vessel 10 can thereby be achieved in a similar manner.

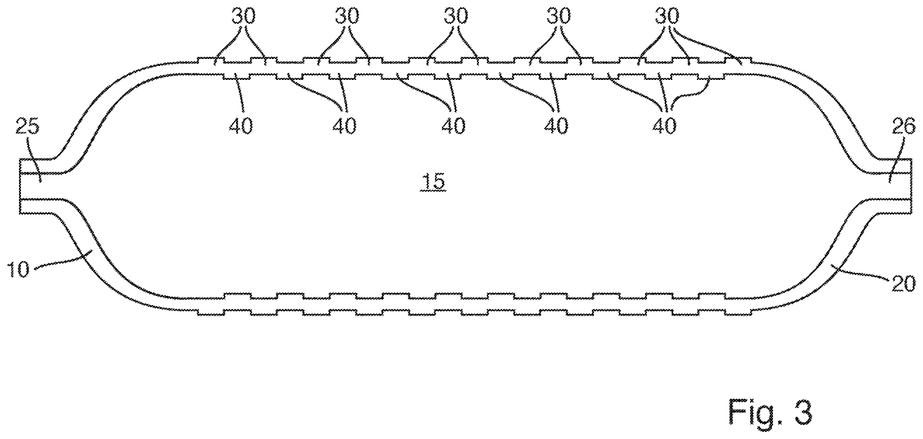

FIG. 3 shows a pressure vessel 10 according to a third embodiment. Both outer ribs 30 and inner ribs 40 are formed here. As is shown, the ribs 30, 40 alternate axially with one another, such that an outer rib 30 always immediately follows an inner rib 40. In this way too, the strength can be advantageously increased. Alternatively, it would also be possible, for example, to provide axial distances between the inner ribs 40 and the outer ribs 30.

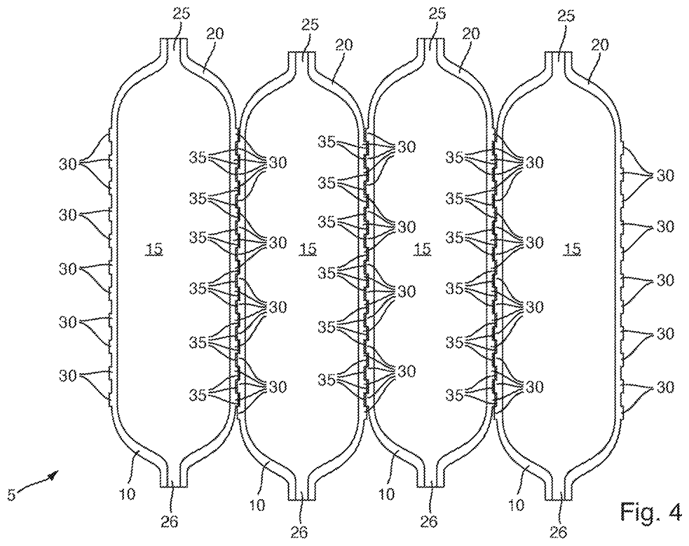

FIG. 4 shows a pressure vessel system 5 according to a first embodiment. A total of four pressure vessels 10 are shown, and reference may be made to FIG. 1 for their description.

As is shown, the pressure vessels 10 are arranged such that respective outer ribs 30 engage in respective interstices 35 between outer ribs 30 of the respectively adjacent pressure vessels 10. Since the pressure vessels 10 are all identical to one another, this requires a slight offset along the longitudinal directions of the pressure vessels 10. This means that identical pressure vessels 10 can be used. The space needed can be reduced by the engagement of the ribs 30 in interstices 35, and stability can be achieved by the ribs 30 clamping with a form fit onto the ribs 30 touching them from a respectively adjacent pressure vessel 10. As a result, a certain force-fit connection can also be built up, by which the pressure vessel system 5 is stabilized.

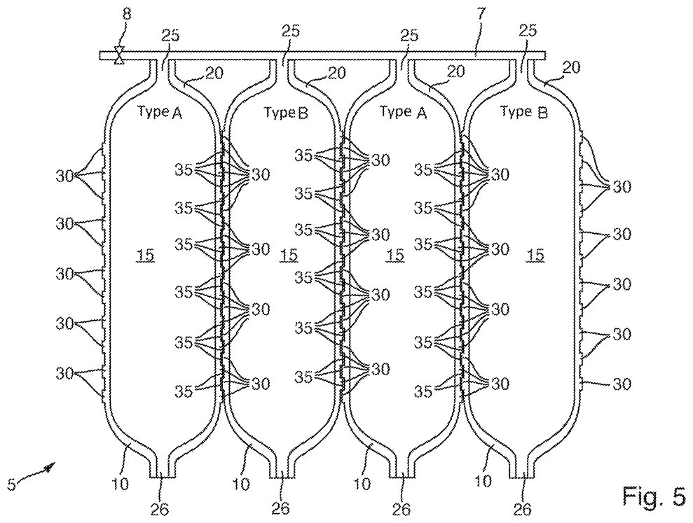

FIG. 5 shows a purely schematic view of a pressure vessel system 5 according to a second embodiment. In contrast to the embodiment of FIG. 4, two different types of pressure vessels 10 are used here, namely type A and type B. These are indicated in FIG. 5. The types of pressure vessels 10 differ only in that the outer ribs 30 are offset from one another in such a way that the otherwise identical pressure vessels 10 can be arranged directly adjacent to one another and without any axial offset with respect to their longitudinal directions, and yet respective outer ribs 30 nonetheless engage in respective interstices 35 of adjacent pressure vessels 10. In particular, this permits simpler neck mounting, that is to say mounting of the pressure vessels 10 at their respective longitudinal ends.

In the embodiment of FIG. 5, the pressure vessels 10 are connected by a common connection line 7. This enables pressure equalization between the pressure vessels 10 at any time, which is not affected by valves. As a result, the pressure vessels 10 have the same internal pressure at all times. In the event of pressure fluctuations, they therefore expand and contract evenly. Opposite the connection line 7, the pressure vessels 10 can be individually closed, for example, or they can be connected in some other way.

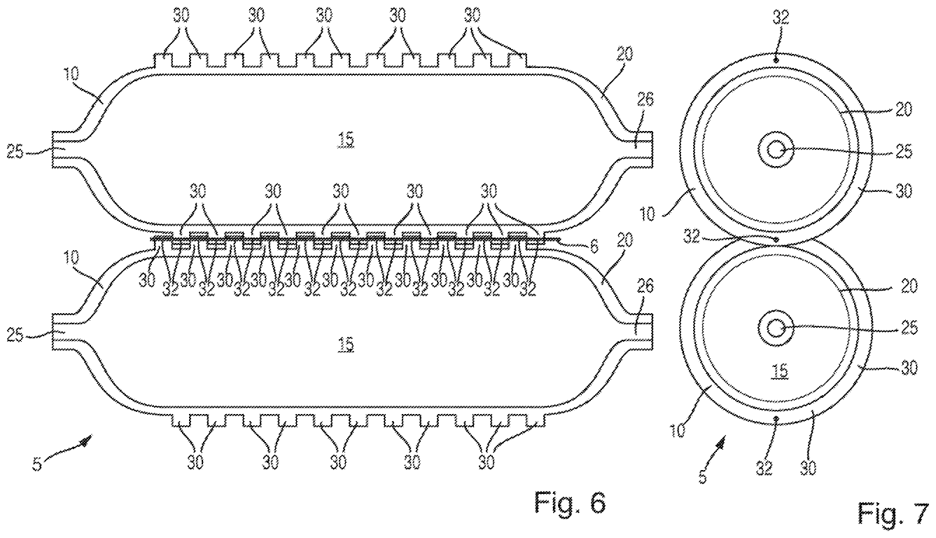

FIG. 6 shows a modification of the embodiment of FIG. 5 in that the outer ribs 30 have respective aligned through-holes 32, through which a fastener 6 in the form of an elongate wire runs. The two pressure vessels 10 can be positively connected to each other by such a fastener 6, so that it becomes impossible to remove them from each other without first loosening the fastener 6. With this type of connection there typically remains a degree of freedom in the form of a rotation about the fastener 6. This degree of freedom can be compensated, for example, by suitable support elements in such a way that the pressure vessels 10 have a defined position in relation to each other.

FIG. 7 shows the pressure vessel system 5 from FIG. 6 in a schematic cross-sectional view. It can be seen here that the through-holes 32 are formed on the outside in a respective outer rib 30. The ribs 30 engage in respective interstices 35 of the adjacent pressure vessels 10, and the through-holes 32 are aligned such that the fastener 6 in the form of an elongate wire can be pushed through without any problem.

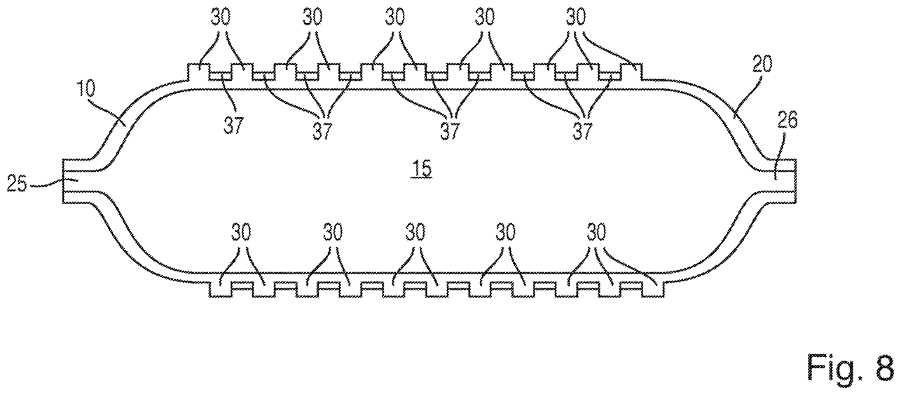

FIG. 8 shows a pressure vessel 10 according to a fourth embodiment. Circumferential reinforcement layers 37 made of carbon fiber reinforced plastic (CFRP) are arranged between the ribs 30 arranged on the outside. They have a greater strength than the steel otherwise used here, and they can therefore have a smaller external diameter than the ribs 30. In this case, the ribs 30 act as mechanical protection for the reinforcement layers 37.

For reasons of readability, the expression “at least one” has sometimes been omitted for the sake of simplicity. If a feature of the technology disclosed here is described in the singular or with an indefinite article (e.g. the/a pressure vessel, the/a rib, etc.), the plural thereof is also intended to be disclosed at the same time (e.g. the at least one pressure vessel, the at least one rib, etc.).

The foregoing description of the present invention serves only for illustrative purposes and not for the purpose of restricting the invention. Various changes and modifications are possible in the context of the invention without departing from the scope of the invention and the equivalents thereof.

### LIST OF REFERENCE SIGNS

5 pressure vessel system
6 fastener
7 connection line
8 valve
10 pressure vessel
15 interior
20 vessel wall
25 first port
26 second port
30 outer rib
32 through-holes
35 interstices
37 reinforcement layers
40 inner ribs

1.-35. (canceled)

36. A pressure vessel for storing gaseous fuel, comprising:
a vessel wall which encloses an interior; and
one or more ribs formed on the vessel wall.

37. The pressure vessel according to claim 36, wherein
one, some, or all of the ribs are formed from a same material as the vessel wall; and/or
one, some or all of the ribs are formed from a different material than the vessel wall;
wherein one, some or all of the ribs are formed from metal or from carbon fiber reinforced plastic.

38. The pressure vessel according to claim 36, wherein
adjoining planes of some or all of the ribs are oriented parallel to one another.

39. The pressure vessel according to claim 36, wherein
the ribs are of a same width and/or are at same distances from immediately adjacent ribs.

40. The pressure vessel according to claim 36, wherein
a wall thickness of the pressure vessel between the ribs is at least 5.4 mm and/or at most 7.5 mm.

41. The pressure vessel according to claim 36, wherein
a height of the ribs relative to an immediately surrounding vessel wall is at least 1 mm, at least 2 mm, at least 4 mm or at least 6 mm; and/or
a height of the ribs relative to the immediately surrounding vessel wall is at most 2 mm, at most 3 mm, at most 4 mm, at most 6 mm or at most 7 mm.

42. The pressure vessel according to claim 36, wherein
a width of the ribs is at least 20 mm, at least 25 mm, at least 30 mm or at least 35 mm; and/or
a width of the ribs is at most 25 mm, at most 30 mm, at most 35 mm or at most 40 mm.

43. The pressure vessel according to claim 36, wherein
a distance between immediately adjacent ribs is at least 10 mm or at least 15 mm; and/or
a distance between immediately adjacent ribs is at most 15 mm or at most 20 mm.

44. The pressure vessel according to claim 36, further comprising;
one or more circumferential reinforcement layers formed between immediately adjacent outer ribs.

45. The pressure vessel according to claim 44, wherein
the reinforcement layers are formed from carbon fiber reinforced plastic.

46. The pressure vessel according to claim 44, wherein
the reinforcement layers are unidirectional.

47. The pressure vessel according to claim 44, wherein
a height of the ribs is at least 20% and/or at most 30% greater than a height of the reinforcement layers.

48. The pressure vessel according to claim 36, further comprising:
a barrier layer formed between the vessel wall and the interior.

49. The pressure vessel according to claim 48, wherein
the barrier layer completely lines an interior of the vessel wall.

50. The pressure vessel according to claim 48, wherein
the barrier layer is formed from ethylene vinyl alcohol copolymer.

51. The pressure vessel according to claim 50, wherein
the barrier layer has an ethylene content of between 20 mol % and 28 mol %, or of 24 mol %.

52. The pressure vessel according to claim 48, wherein
the barrier layer has a thickness of between 80 μm and 250 μm.

53. The pressure vessel according to claim 48, further comprising:
a metal layer arranged between the barrier layer and the vessel wall.

54. The pressure vessel according to claim 53, wherein
the metal layer is formed from copper or a copper alloy.

55. The pressure vessel according to claim 48, wherein
all of the ribs are on an exterior of the vessel wall.

56. The pressure vessel according to claim 36, further comprising:
an anti-corrosion layer applied to an exterior of the vessel wall.

57. The pressure vessel according to claim 56, wherein
the anti-corrosion layer is formed from a zinc-nickel alloy.

58. The pressure vessel according to claim 36, wherein
one, some or all of the ribs are on an interior of the vessel wall.

59. The pressure vessel according to claim 36, wherein
one, some or all of the ribs are on an exterior of the vessel wall.

60. A pressure vessel system, comprising:
two or more pressure vessels, each pressure vessel comprising:
a vessel wall which encloses an interior;
one or more ribs formed on the vessel wall.
wherein the ribs of one, some or all of the two or more pressure vessels engage in interstices between the ribs of one or more immediately adjacent pressure vessels.

61. The pressure vessel system according to claim 60, wherein
longitudinal axes of the two or more pressure vessels are oriented parallel to one another.

62. The pressure vessel system according to claim 60, wherein
the ribs of immediately adjacent pressure vessels are designed without any axial offset from one another relative to at least one longitudinal end of the pressure vessel, and
immediately adjacent pressure vessels are arranged axially offset from one another.

63. The pressure vessel system according to claim 60, wherein
the ribs of immediately adjacent pressure vessels are designed axially offset from the immediately adjacent pressure vessel, and
immediately adjacent pressure vessels are arranged axially non-offset from one another with respect to a longitudinal end or both longitudinal ends.

64. The pressure vessel system according to claim 60, wherein
aligned through-holes are formed in ribs of immediately adjacent pressure vessels through which a fastener extends.

65. The pressure vessel system according to claim 60, wherein
the ribs of immediately adjacent pressure vessels are connected to one another by force-fit engagement.

66. The pressure vessel system according to claim 60, wherein
the two or more pressure vessels are connected by a common connection line, wherein a pressure equalization between the two or more pressure vessels is not impaired at any time by valves.

67. A motor vehicle, comprising:
a pressure vessel system according to claim 60; and
an underfloor installation space, wherein the pressure vessel system is installed in the underfloor installation space of the motor vehicle.

68. A method for forming ribs on a vessel wall of a pressure vessel, comprising at least one of the following acts:
(i) separately producing the ribs and force-fit applying of the ribs to the vessel wall by cold forming;
(ii) applying an internal pressure to the pressure vessel, thereby cold-forming the pressure vessel in order to form the ribs, or
(iii) separately producing the ribs and thermally shrinking the ribs onto the vessel wall.

69. The method according to claim 68, further comprising:
introducing a barrier layer to an interior of the vessel wall.

70. The method according to claim 69, wherein
the introducing is carried out by roto-molding, blow molding or extrusion.
